(19) United States
(12) Patent Application Publication
(10) Pub. No.: US 2007/0159934 A1
(43) Pub. Date: Jul. 12, 2007

(54) Method for providing jukebox service using network

(75) Inventor: Tae-hwan Weon, Gyeonggi-do (KR)

Correspondence Address: INTELLECTUAL PROPERTY LAW GROUP LLP, 12 SOUTH FIRST STREET, SUITE 1205, SAN JOSE, CA, 95113, US

(73) Assignee: Digital Wave, Inc., Seoul (KR)

(21) Appl. No.: 10/578,934

(22) PCT Filed: Oct. 21, 2004
(86) PCT No.: PCT/KR04/02697

§ 371 Date: May 8, 2006

(30) Foreign Application Priority Data
Nov. 10, 2003 (KR) 10-2003-0079239

(51) Int. Cl. G11B 7/085; G06F 17/30

(52) U.S. Cl. 369/30.06; 707/1

(57) ABSTRACT

In the prior art, there is a limitation in providing services, such as a jukebox service, using a network, such as the Internet. The jukebox service provision method of the present invention uses a jukebox terminal (160) provided with an RF transmission means (165). The jukebox terminal (160) accesses a server (110) to transmit the authentication information therefor and receives a playlist from the server. The jukebox terminal (160) requests one or more the server, receives the requested sound source data in the received playlist from the server, receives the requested sound source date and transmits the received sound source data to an audio system (170) using the RF transmission means (165).

### TECHNICAL FIELD

The present invention relates, in general, to methods for providing a jukebox service using a network and, more particularly, to a method for providing a service, such as a jukebox service, by allowing a dedicated server to transmit sound source data, such as music, to a dedicated terminal through a network, such as the Internet, and connecting the dedicated terminal to an audio system in a wireless manner to play the sound source data.

### BACKGROUND ART

A jukebox is a machine that is implemented with buttons and is operated in such a way that a user listens to a desired piece of music when the user inserts a coin into the mechanism and selects the desired music from the data recorded on a plurality of recording media in the jukebox. That is, if a coin is inserted into a coin slot of the jukebox and a desired piece of music is selected from the data recorded on the plurality of recording media, the music recorded on the recording media (magnetic tape, disk, Compact Disk (CD) Read Only Memory (ROM), etc.) is output through a sound output device, such as a speaker, at the same time that the music is played. However, such a jukebox service is basically provided offline, so that there is a limitation in that a plurality of recording media must be included in the jukebox so as to play music.

In the meantime, with the rapid popularization of ultra high speed Internet, a user frequently downloads pieces of music through the Internet and listens to the music through his or her computer. Further, the provision of services of playing music in a real-time streaming manner, called Internet broadcasting, has become widely known. However, in actuality, a method of combining the download method with the streaming method and providing a jukebox service through the Internet has not yet been proposed.

### DESCRIPTION OF DRAWINGS

FIGS. 1 and 2 are views showing the construction of a system according to embodiments of the present invention;

FIG. 3 is a view showing the detailed construction of a jukebox terminal;

FIG. 4 is a view showing application programs stored in the jukebox terminal according to modules;

FIG. 5 is a flowchart of a method according to an embodiment of the present invention;

FIG. 6 is a flowchart of a process of selecting and editing a playlist;

FIG. 7 is a view showing examples of playlists;

FIG. 8 is a flowchart showing the construction of a method according to another embodiment of the present invention;

FIGS. 9 and 10 are views showing the construction of a system according to other embodiments of the present invention;

FIG. 11 is a flowchart showing the construction of a method according to a further embodiment of the present invention; and

FIG. 12 is a flowchart showing the construction of a method according to yet another embodiment of the present invention.

### DISCLOSURE

### Technical Problem

Accordingly, the present invention has been made keeping in mind the above problems, and an object of the present invention is to provide a method for providing a jukebox service through a network, such as the Internet. That is, the object of the present invention is to provide a method for providing a jukebox service by storing sound source data in a server, transmitting a playlist and sound source data to a dedicated terminal through the Internet and allowing the dedicated terminal to transmit the sound source data to an audio system as Radio Frequency (RF) signals.

### Technical Solution

In order to accomplish the above object, the present invention provides a method for providing a jukebox service using a network, the method being implemented using a server that is connected to at least one jukebox terminal through the network and stores sound source data and playlists according to jukebox terminals, comprising the steps of transmitting a playlist preset by a user to a jukebox terminal connected to the server through the network; receiving a request for one or more pieces of sound source data in the playlist from the jukebox terminal; and searching for the requested sound source data and transmitting the found sound source data to the jukebox terminal.

Further, the present invention provides a method for providing a jukebox service using a network, the method being implemented using a server that is connected to at least one jukebox terminal through the network and stores sound source data and playlists according to jukebox terminals, comprising the steps of receiving jukebox authentication information, including an IP address and a unique ID of a jukebox terminal, from the jukebox terminal connected to the server through the network; identifying the jukebox terminal on the basis of the received jukebox authentication information, searching for a playlist preset with respect to the identified jukebox terminal; transmitting the playlist found for the jukebox terminal to the jukebox terminal on the basis of the received IP address; receiving a request for one or more pieces of sound source data in the playlist from the jukebox terminal; and transmitting the requested sound source data to the jukebox terminal.

Further, the step of transmitting the requested sound source data to the jukebox terminal may comprise the step of transmitting additional information related to the requested sound source data, together with the requested sound source data.

Further, at the step of receiving the sound source data request from the jukebox terminal, the sound source data request may be a sequential request for one or more pieces of sound source data in the playlist.

Further, at the step of receiving the sound source data request from the jukebox terminal, the sound source data request may be a random request for one or more pieces of sound source data in the playlist.

Further, the jukebox service provision method may further comprise the step of generating a Usage Data Record (UDR) after transmitting the requested sound source data to the jukebox terminal.

Further, according to another aspect of the present invention, the present invention provides a method for providing a jukebox service using a jukebox terminal, connected to a server for storing sound source data and playlists according to jukebox terminals through a network and provided with RF transmission means, comprising the steps of accessing the server through the network to receive a preset playlist; transmitting a request for one or more pieces of sound source data in the received playlist to the server; receiving the requested sound source data; and transmitting the received sound source data to the audio system using the RF transmission means.

Further, the present invention provides a method for providing a jukebox service using a jukebox terminal, connected to a server for storing sound source data and playlists according to jukebox terminals through a network and provided with RF transmission means, comprising the steps of accessing the server through the network to transmit jukebox authentication information including an IP address and a unique ID of a jukebox terminal; receiving a playlist based on the transmitted authentication information from the server; transmitting a request for one or more pieces of sound source data in the received playlist to the server; receiving the requested sound source data, and transmitting the received sound source data to an audio system using the RF transmission means.

Further, according to a further aspect of the present invention, the present invention provides a method for providing a jukebox service using a network, the method being implemented using a server that is connected to at least one jukebox terminal including playlists through the network and stores sound source data, comprising the steps of receiving a request for one or more pieces of sound source data in a corresponding playlist from the jukebox terminal connected to the server through the network; and searching for the requested sound source data and transmitting the found sound source data to the jukebox terminal.

Further, the present invention provides a method for providing a jukebox service using a network, the method being implemented using a server that is connected to a jukebox terminal including playlists through the network and stores sound source data, comprising the steps of receiving jukebox authentication information, including an IP address and a unique ID of a jukebox terminal, from the jukebox terminal connected to the server through the network; identifying the jukebox terminal on the basis of the received jukebox authentication information and receiving a request for one or more pieces of sound source data in a corresponding playlist from the identified jukebox terminal; and transmitting the requested sound source data to the jukebox terminal.

Further, according to yet another aspect of the present invention, the present invention provides a method for providing a jukebox service using a jukebox terminal, the jukebox terminal being connected to a server for storing sound source data through a network and being provided with playlists and RF transmission means, comprising the steps of accessing the server through the network and transmitting a request for one or more pieces of sound source data in a corresponding playlist to the server; receiving the requested sound source data; and transmitting the received sound source data to an audio system using the RF transmission means.

Further, the present invention provides a method for providing a jukebox service using a jukebox terminal, the jukebox terminal being connected to a server for storing sound source data through a network and being provided with playlists and RF transmission means, comprising the steps of accessing the server through the network to transmit jukebox authentication information including an IP address and a unique ID of a jukebox terminal; transmitting a request for one or more pieces of sound source data in a corresponding playlist to the server if authentication is verified by the server; receiving the requested sound source data; and transmitting the received sound source data to the audio system using the RF transmission means.

Further, according to still another aspect of the present invention, the present invention provides a jukebox terminal, the jukebox terminal including a central control unit and a memory unit and being connected to a server for storing sound source data through a network to provide the jukebox service, comprising a network transmission/reception unit for transmitting/receiving sound source data to/from the server through the network; and an RF transmission module for processing received sound source data and transmitting the processed sound source data to an external audio system as RF signals, wherein the memory unit stores playlists therein, requests one or more pieces of sound source data from the server according to the playlists, receives the requested sound source data from the server and transmits the received sound source data to the external audio system as RF signals using the RF transmission module.

Further, according to still another aspect of the present invention, the present invention provides a jukebox terminal, the jukebox terminal including a central control unit and memory and being connected to a server for storing sound source data and playlists through a network to provide the jukebox service, comprising a network transmission/reception unit for transmitting/receiving sound source data to/from the server through the network; and an RF transmission module for combining the received sound source data with each other and transmitting the combined sound source data to an external audio system as RF signals, wherein the jukebox terminal accesses the server to receive the playlists, requests one or more pieces of sound source data according to the playlists from the server, receives the requested sound source data from the server and transmits the received sound source data to the external audio system as RF signals using the RF transmission module.

### Advantageous Effects

According to the present invention, a method for providing a jukebox service through a network, such as the Internet, can be provided. That is, according to the present invention, there is provided the jukebox service by storing sound source data in a server, transmitting playlists and sound source data to a dedicated terminal through the Internet and allowing the dedicated terminal to transmit the sound source data to an audio system as RF signals, thus conveniently providing the jukebox service.

Further, according to the present invention, since sound source data are automatically played depending on a preset program, users unfamiliar with computers can easily be provided with the jukebox service.

Further, in the prior art, a conventional high quality music service, for example, a service using a satellite, has been provided as a conventional music related service, but the conventional service is maintained using several tens of unidirectional channels and it is actually difficult to provide bidirectionality, reflect subscribers' preferences or develop additional services. In contrast, the present invention is advantageous in that it can establish an almost infinite number of virtual channels by satisfying users' preferences, time zones and various shops' demands in the case of shops.

### Best Mode

Hereinafter, embodiments of the present invention will be described in detail with reference to the attached drawings.

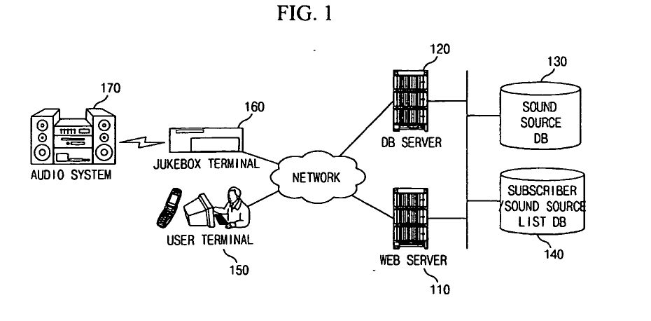

FIG. 1 is a view showing the construction of a system according to an embodiment of the present invention. As shown in FIG. 1, the system according to the embodiment of the present invention includes a Web server 110, a database server (hereinafter simply referred to as a DB server) 120, a sound source DB 130, a subscriber/sound source list DB 140, a user terminal 150, a jukebox terminal 160 and an audio system 170.

The Web server 110 is connected to both the user terminal 150 and the jukebox terminal 160 through the Internet, and is internally connected to the DB server 120, the sound source DB 130 and the subscriber/sound source list DB 140. The Web server 110 includes the function of a typical Web server to process requests from users accessing the Web server 110 through the Internet and provide services through a World Wide Web (WWW) to the users. The Web server 110 is connected to the DB server 120 and the DBs 130 and 140 to function to completely manage an entire service.

The DB server 120, which is a server for managing the sound source DB 130 and the subscriber/sound source list DB 140, is connected to the Web server 110. The DB server 120 is directly connected to the jukebox terminal 160, which will be described later, through the network, thus directly transmitting music data (sound source data) to the jukebox terminal 160. A plurality of DB servers 120 and sound source DBs 130 may be physically installed and managed thereby. For example, when the number of users increases, the total amount of traffic increases, so that a plurality of sound source DBs 130 or the sound source DBs 130 and the DB servers 120 can be distributed to a plurality of regions and arranged therein, thus supporting load balancing. In this case, it is preferable that the Internet Protocol (IP) address of a sound source DB 130 to be accessed by the jukebox terminal 160 is received from a central server at the time of access authentication and used.

The sound source DB 130, which is a DB for storing therein data about sound sources themselves to be played through the jukebox terminal 160, stores data including all types of data playable through a computer. The type of stored data is not limited, but may have a compressed data format, such as an MP3 format. Further, the sound source data may be data normally stored on a CD, and may occasionally be a CD itself. Further, moving image data, such as Audio-Video Interleaved (AVI), Moving Picture Experts Group (MPEG) or Windows Media Audio (WMA) format data, may also be stored in the sound source DB 130.

In the meantime, the subscriber/sound source list DB 140 stores therein various pieces of subscriber information including the IDs and passwords of subscribers, and stores sound source lists preset with respect to each of the subscribers. Further, the subscriber/sound source list DB 140 may store various parameters, such as environmental settings, according to subscribers. For example, the subscriber/sound source list DB 140 may include data indicating whether to sequentially or randomly play sound sources on a sound source list at the time of playing sound sources. Further, the subscriber/sound source list DB 140 can be constructed to include and store data about the usage record for each of the subscribers. The data about the usage record can be used in, for example, billing according to subscribers, etc.

In the meantime, in the drawing, the user terminal 150 refers to a terminal having a function of accessing the Internet, such as a Personal Computer (hereinafter simply referred to as a ‘PC’), a Personal Digital Assistant (PDA), or a mobile phone. The user terminal 150 accesses the Web server 110 to command the user's desired operation and control various setting operations. Representatively, the user may personalize his or her settings by editing a playlist. That is, the user accesses the server through the terminal 150 and is capable of setting various operations, such as the selection, addition, deletion and arrangement of music lists to be played through the jukebox terminal 160.

In the meantime, the jukebox terminal 160 of FIG. 1 functions to receive sound source data selected by the user using the network, transmit the sound source data to the audio system 170 and play the sound source data. If the power of the jukebox terminal 160 is turned on, the jukebox terminal 160 directly accesses the Web server 110 or the DB server 120 through the network immediately after performing a typical examining operation using a program included in the jukebox terminal 160, thus confirming music lists preset by the user through the user terminal 150, directly downloading music data (sound source data), storing the music data in a memory, transmitting the music data to the audio system 170 as RF signals and playing the music. The detailed construction and operation of the jukebox terminal 160 will be described later.

The audio system 170, which is a typical audio system, receives data in the form of radio broadcasting using RF signals from the jukebox terminal 160, so that the audio system 170 is preferably provided with a function of receiving typical (Frequency Modulation: FM) radio broadcasting.

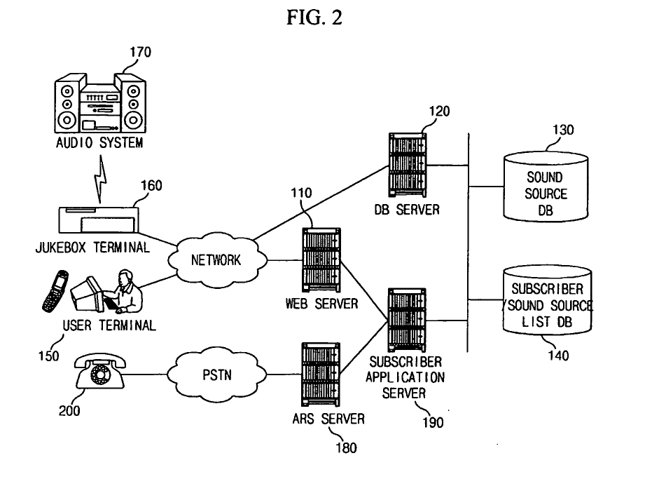

FIG. 2 illustrates another embodiment of FIG. 1, and shows a system including an Automatic Response System (ARS) server 180. In the system of FIG. 2, a user may access the ARS server 180 through a Public Switched Telephone Network (PSTN) and set various operations, such as the selection, addition, deletion and arrangement of music lists to be played through the jukebox terminal 160, as described above, depending on the guidance provided from the ARS server 180. When the ARS server 180 is provided in this way, a subscriber application server 190 for integrating the Web server 110 with the ARS server 180 may be provided, as shown in FIG. 2.

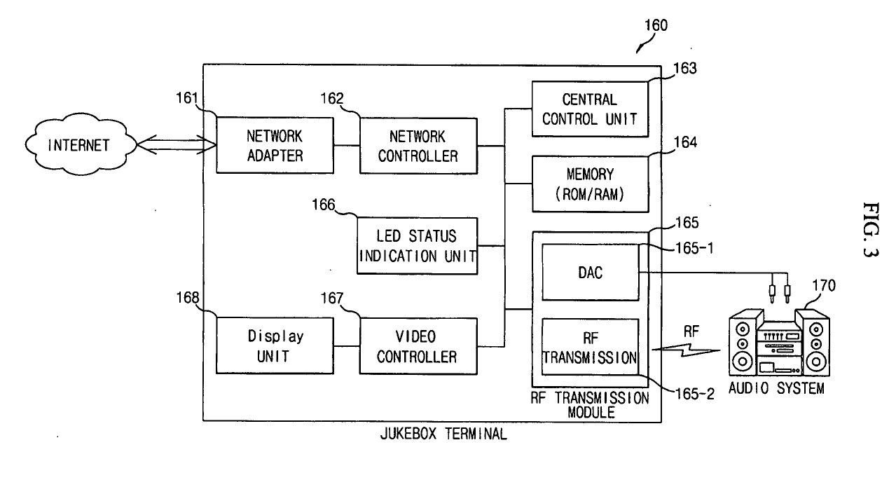

FIG. 3 is a view showing the detailed construction of the jukebox terminal 160 of FIG. 1.

As shown in FIG. 3, the jukebox terminal 160 includes a central control unit 163, a memory 163, a network controller 162, a network adapter 161, an RF transmission module 165, a Light Emitting Diode (LED) status indication unit 166, a video controller 167 and a display unit 168.

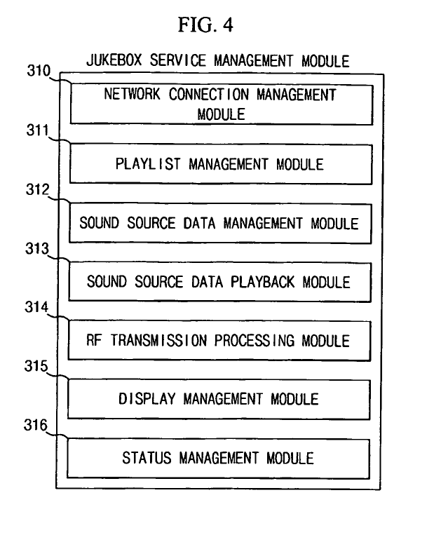

The central control unit 163 can be implemented using a universal microprocessor, which controls the entire operation of the jukebox terminal 160. The memory 163 may be constructed to include a Read Only Memory (ROM) and a Random Access Memory (RAM). The ROM stores therein an Operating System (OS), and various application programs. An operating system for small-sized terminals, for example, Windows CE or Embedded Linux, can be used for the OS. The various application programs stored in the ROM are required to allow the jukebox terminal 160 to transmit/receive data to/from the server, store and play received sound source data, and transmit the sound source data to the audio system as RF signals. A detailed description thereof will be made with reference to FIG. 4.

Further, the ROM stores therein unique IDs preset according to jukebox terminals 160, and can also store passwords of the jukebox terminals 160 if necessary. Further, the ROM also stores information, such as the IP address of the DB server 120 to be directly accessed by the jukebox terminal 160.

The network controller 162 and the network adapter 161 are connected to the network, such as the Internet, to transmit/receive and control data. In FIG. 3, the network adapter 161 denotes an input/output port, such as an RJ-45 port, and the network controller 162 denotes a means for controlling data transmitted/received by the network adapter 161. The network controller 162 and the network adapter 161 are separately shown in FIG. 3, but they can be collectively designated as a network interface. As described above, the network controller 162 and the network adapter 161 transmit/receive various pieces of data to/from the DB server 120, in particular, directly receive sound source data and store the sound source data in the memory 164 through the central control unit 163 or directly store the sound source data in the memory 164.

The RF transmission module 165 is a module for transmitting sound source data to the external audio system 170 as RF signals, and includes a Digital-Analog Converter (DAC) 165-1 and an RF transmitter 165-2. The DAC 165-1, which is a sound processing module for outputting analog data to be transmitted as RF signals, receives digital sound source data to be played from the memory and the central control unit 163 and outputs the sound source data as analog data. Such a DAC 165-1 can be constructed to include a line output port, and then be directly connected to the audio system 170.

The RF transmitter 165-2 transmits the analog data output from the DAC 165-1 to the external audio system 170 as RF signals. Such an RF transmitter 165-2 can be implemented using a conventional transmitter.

Further, the jukebox terminal 160 may include the LED status indication unit 166 for externally indicating the status of the terminal. The user can easily identify the status of the terminal (for example, data reception status, data playback status, network connection status, etc.).

Further, the jukebox terminal 160 may include the video controller 167 and the display unit 168 for playing moving image data. The display unit 168 may be a display unit (for example, Liquid Crystal Display (LCD)) included in the jukebox terminal 160 itself, and may be an output port for connecting to external devices (TV, computer monitor, etc.) as a simple display output port.

FIG. 4 is a view showing application programs stored in the jukebox terminal 160 of FIG. 3 according to modules. As shown in FIG. 4, a jukebox service management module can be constructed to include a network connection management module 310, a playlist management module 311, a sound source data management module 312, a sound source data playback module 313, an RF transmission processing module 314, a display management module 315, and a status management module 316.

The network connection management module 310 manages the network adapter and controller of FIG. 3 to process functions, such as the management of the connection and interface with the network. The playlist management module 311 manages stored playlists and performs playlist-related management, such as management about whether playlists are valid, which music is being currently played and what is the next music to be played.

The sound source data management module 312 is a module for managing sound source data received from the DB server, and performs functions, such as the storage, fetch and update of sound source data. The sound source data playback module 313 denotes a module for processing and playing the sound source data, and may be constructed to include a DAC, etc.

The RF transmission processing module 314 is a module for executing processing to transmit the sound source data to the audio system as RF signals using the DAC and the RF transmitter. The display management module 315 is a module for managing display together with the video controller 167 and the display unit 168. The display management module 315 is required only when the jukebox terminal 160 is provided with the display unit 168 and the video controller 167 of FIG. 3.

The status management module 316 externally indicates the status of the device through the LED status indication unit 166 while monitoring the status of the entire device.

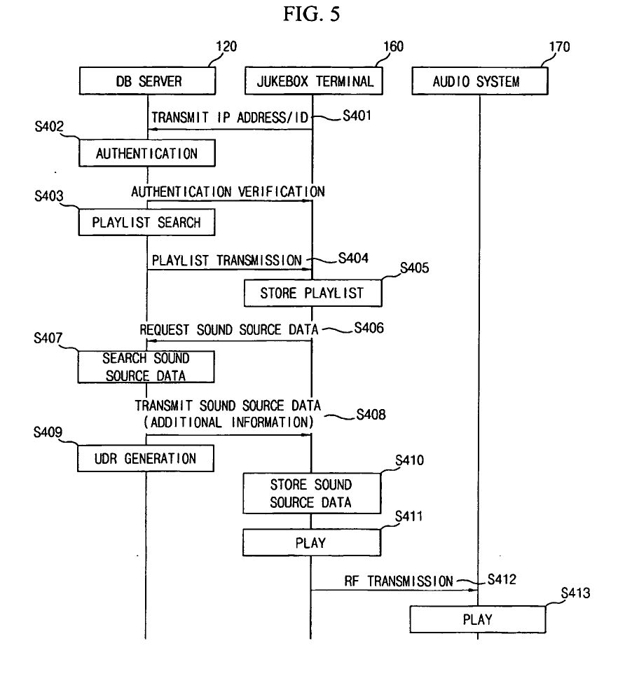

FIG. 5 is a flowchart of a method according to an embodiment of the present invention.

First, the jukebox terminal 160 accesses the DB server 120 and transmits an IP address and an ID at step S401. The jukebox terminal 160 can store the IP address of the DB server 120 in advance and use the stored IP address when accessing the DB server 120. The IP address transmitted to the DB server 120 is necessary for the DB server 120 to transmit data to the jukebox terminal 160. If the jukebox terminal 160 has a fixed IP, it transmits the fixed IP. For example, in the case of the Internet user using an Asymmetric Digital Subscriber Line (ADSL) or cable TV connection that has been recently and widely popularized over a country, an IP address allocated by an ADSL server is transmitted. This operation is preferably automatically performed by the operating system and application programs stored in the ROM when the power of the jukebox terminal is turned on. In this case, a password can be transmitted in addition to the IP address and the ID.

Next, the DB server 120 authenticates the received IP address and ID at step S402. In this case, the authentication means an operation of determining whether the received ID exists in the subscriber DB 140. If the password is also received, it can be determined whether the ID and the password are correct. Although not shown in the drawing, the authentication can be directly processed by the DB server 120 or processed by the Web server 110, with reference to the subscriber/sound source list DB 140.

Next, the DB server 120 searches the subscriber/sound source list DB 140 for a playlist according to the ID using the authenticated ID at step S403, and transmits the found playlist to the jukebox terminal 160 at step S404.

The jukebox terminal 160 stores the received playlist at step S405, and requests desired sound source data in the playlist from the DB server 120 at step S406. The request for the sound source data can be performed so that one or more pieces of sound source data in the playlist can be requested, but the number of pieces of sound source data requested can be limited to a certain number in consideration of the capacity, maintenance and management of the memory. In the meantime, the request for the sound source data can be performed so that the sound source data existing in the playlist are sequentially or randomly requested.

The DB server 120 receives the request for the sound source data and searches for corresponding sound source data at step S407, and transmits the found sound source data to the jukebox terminal 160. At this time, additional information (composer, genre, playback time, sampling rate, album title, etc.) related to the corresponding sound source data, in addition to the sound source data, can be included and transmitted together.

The DB server 120 completes the transmission of the sound source data, and then generates a UDR. The UDR is a simplified form of a usage detail record, and indicates data in which usage records are stored according to IDs. For example, all records related to usage, such as records indicating when and what a user having an ID “A” has requested and received and how many pieces of music the user “A” has received, are stored. These are data that are not only helpful to monitor, maintain and manage the system but are also used for billing, etc.

In the meantime, the jukebox terminal 160 stores the sound source data transmitted from the DB server 120 at step S410, and plays the sound source data at step S411. Further, the jukebox terminal 160 transmits the sound source data to the external audio system 170 using the internal RF transmission module 165 (refer to FIG. 3) at step S412, and the audio system plays the sound source data at step S413. However, the playback through the jukebox terminal 160 means that music is output from the jukebox terminal 160 itself, so that step S411 can be omitted when music is not output from the jukebox terminal 160.

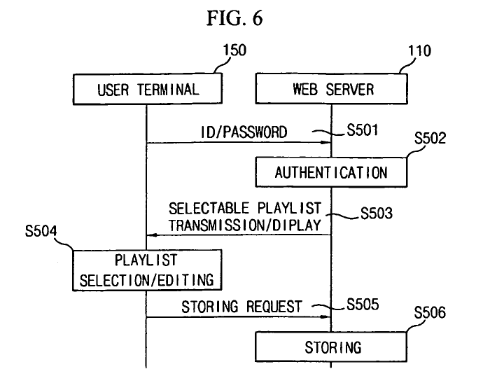

Next, with reference to FIG. 6, a process of selecting and editing a playlist is described. FIG. 6 shows a case where the user terminal 150 accesses the Web server 110 to edit a playlist.

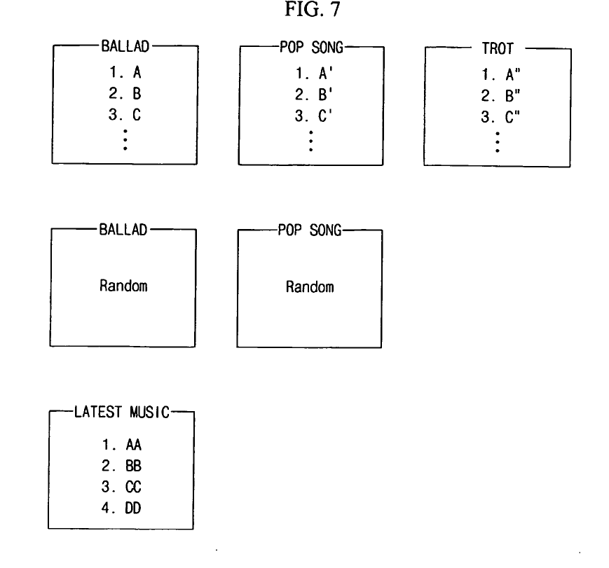

If the user terminal 150 transmits an ID and/or a password to the Web server 110 at step S501, the Web server 110 authenticates the corresponding ID and/or password at step S502, and transmits a playlist that can be selected by the user to the user terminal 150 after authentication has been completed. FIG. 7 is a view showing examples of playlists. The user can select any one from the playlists classified according to music genre, as shown in FIG. 7. It is preferable that each piece of music included in each of the playlists can be deleted or added. Of course, FIG. 7 shows that playlists each including several pieces of music preset by the server are selected, but it is also possible to show the user a list of all pieces of music stored and allow the user to select each piece of music.

Further, as shown in FIG. 7, it is possible to designate a certain genre and select a playlist on which pieces of music corresponding to the genre are randomly set. Further, a playlist including only the latest pieces of music can be separately provided.

If the playlists are displayed, the user selects a corresponding playlist and edits the playlist at step S503, and then requests the Web server 110 to store the edited playlist at step S504. The Web server 110 stores the edited playlist in the corresponding subscriber DB.

In this state, if the jukebox terminal 160 accesses the DB server 120 as described above, the DB server 120 transmits the stored playlist to the jukebox terminal 160, waits for a request for sound source data and transmits the sound source data.

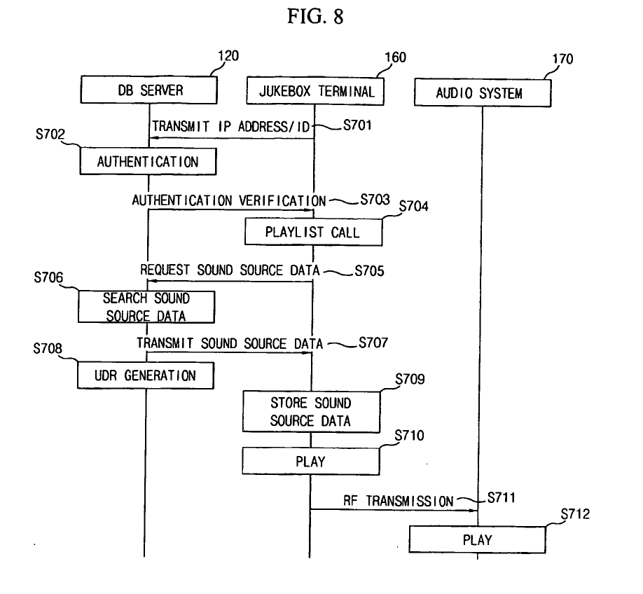

FIG. 8 is a flowchart showing the construction of a method according to another embodiment of the present invention. The embodiment of FIG. 8 is different from the above-described embodiment in that playlists are stored in the jukebox terminal 160. Therefore, the server does not need to maintain separate playlists with respect to each jukebox terminal 160.

First, the jukebox terminal 160 transmits an IP address and an ID (the same as in the case of FIG. 5), and calls a playlist thereof at step S704 if the authentication of the jukebox terminal 160 is verified by the DB server 120 at step S703. The playlist is set in advance using the method described in FIG. 6. The application program of the jukebox terminal 160 can automatically access the DB server 120 to receive a default playlist in preparation for the case where a playlist does not exist at the time of initial installation or due to other reasons.

If the playlist is called, the jukebox terminal 160 requests and receives sound source data and plays the sound source data using the audio system through steps identical to those of FIG. 5.

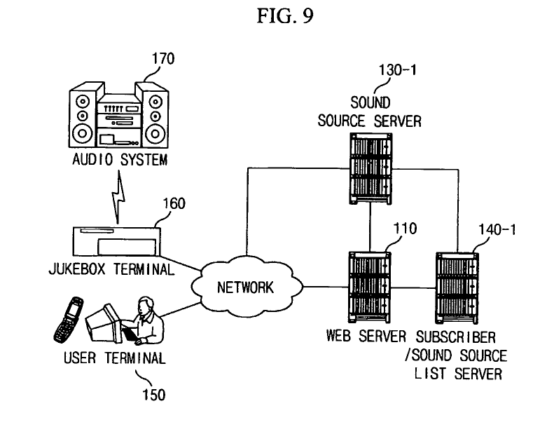

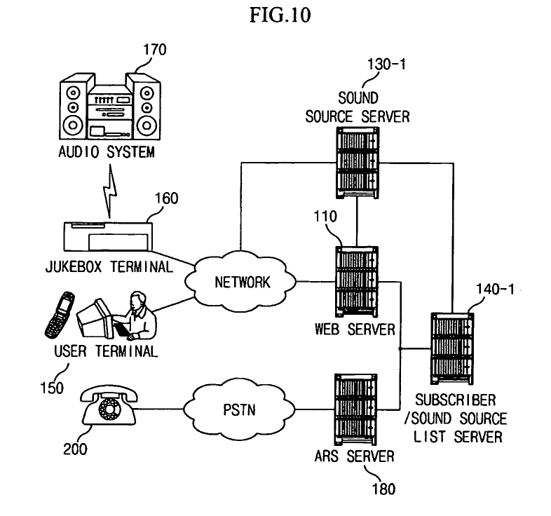

FIGS. 9 and 10 are views showing the construction of a system according to other embodiments of the present invention.

There is a difference between FIGS. 1 and 9 in that FIG. 1 shows that the sound source DB 130 and the subscriber/sound source list DB 140 are provided with respect to one DB server 120, while FIG. 9 shows that the DBs are constructed as separate servers. A subscriber/sound source list server 140-1 of FIG. 9 can be considered to be identical to the subscriber/sound source list DB 140 of FIG. 1 except for a functional difference in that the subscriber/sound source list server 140-1 also functions as a server. A sound source server 130-1 can be considered to be identical to the sound source DB 130 of FIG. 1 except for a functional difference in that the sound source server 130-1 also functions as a server.

The construction of FIG. 10 is identical to that of FIG. 9 except that only an ARS server 180 is added as in the relationship between FIGS. 1 and 2, so that a detailed description thereof is omitted.

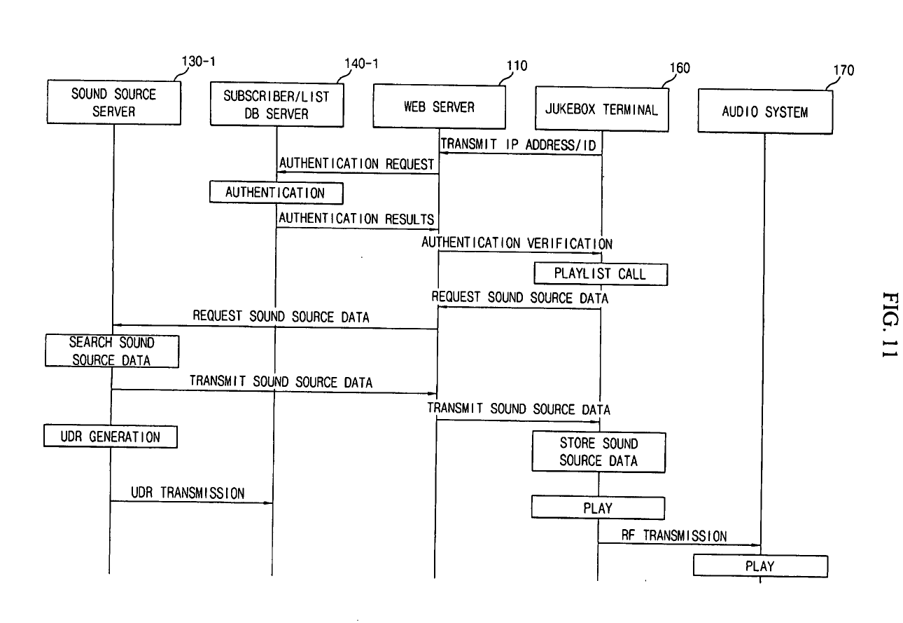

An embodiment of the method of the present invention implemented using the construction of FIG. 9 is depicted in FIG. 11.

First, the jukebox terminal 160 accesses the Web server 110 to transmit an IP address and an ID (password can be included) (refer to FIG. 8). The Web server 110 transmits the received ID (or together with password) to the subscriber/list DB server 140-1, thus requesting subscriber authentication. The subscriber/list DB server transmits authentication results to the Web server 110.

After the authentication is verified, the Web server transmits an authentication verification signal to the jukebox terminal 160, and the jukebox terminal 160 calls a playlist.

The jukebox terminal 160 requests one or more pieces of sound source data according to the called playlist from the Web server 110. The Web server 110 transmits a sound source data request to the sound source server 130-1, and the sound source server searches for corresponding sound source data and transmits the found sound source data to the Web server 110. The Web server 110 transmits the sound source data to the jukebox terminal 160. The subsequent process is executed in the same manner as FIGS. 5 and 8, so that a detailed description thereof is omitted. That is, the method of FIG. 11 is characterized in that the request for the sound source data and the transmission of the sound source data are performed by the Web server.

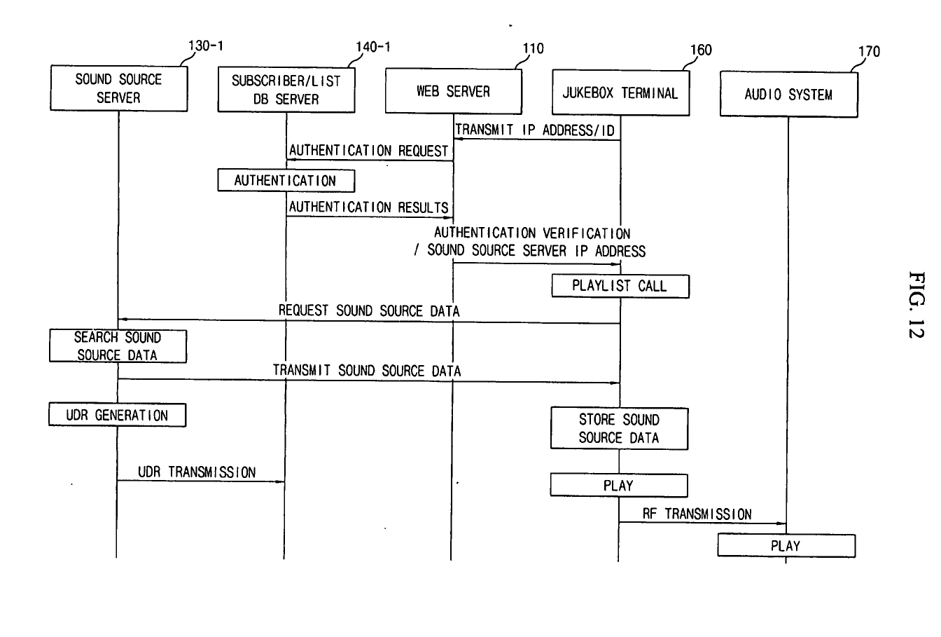

FIG. 12 is a flowchart of a method according to yet another embodiment of the present invention implemented using the construction of FIG. 9.

The embodiment of FIG. 12 is almost identical to that of FIG. 11, but there is a difference in that the request for and transmission/reception of sound source data are directly performed between the sound source server 130-1 and the jukebox terminal 160. For this operation, the jukebox terminal 160 must know the IP address of the sound source server 130-1, which can be received from the Web server 110 at the time of verifying authentication.

As described above, the server can be constructed in various forms as the occasion demands. In the case of the connection with the jukebox terminal, whether the jukebox terminal passes through the Web server or is directly connected to the sound source server can be selected as the occasion demands. Of course, those skilled in the art will easily implement the construction by combining individual steps in the embodiments with each other.

In the meantime, even in the constriction including the ARS server shown in FIGS. 2 and 10, basic principles are equally applied as in the above-described embodiment. However, there is a difference in that the editing of playlists is not set through access to the Web, but a user presses buttons on a telephone depending on the guidance of a voice information system through the ARS server and sets a desired playlist using Dual Tone Multi-Frequency (DTMF) tones.

Those skilled in the art will appreciate that the above-described present invention is not limited to the embodiments and the attached drawings, and various substitutions, modifications and changes are possible, without departing from the spirit of the invention.

1. A method for providing a jukebox service using a jukebox terminal, the jukebox terminal being connected to a server for storing sound source data and playlists according to jukebox terminals through a network and being provided with RF transmission means wherein the jukebox terminal includes a network transmission/reception unit for transmitting/receiving sound source data to/from the server through the network, and the RF transmission means processes the received sound source data and transmits the processed sound source data to an external audio system as RF signals, comprising the steps of:
accessing the server through the network to transmit jukebox authentication information including an IP address and a unique ID of a jukebox terminal;
receiving a playlist on the basis of the authentication information transmitted from the server;
transmitting a request for one or more pieces of sound source data in the received playlist to the server;
receiving the requested sound source data; and
transmitting the received sound source data to the audio system using the RF transmission means.

2. A method for providing a jukebox service using a jukebox terminal, the jukebox terminal being connected to a server for storing sound source data through a network and being provided with playlists and RF transmission means wherein the jukebox terminal includes a network transmission/reception unit for transmitting/receiving the sound source data to/from the server through the network and the RF transmission means processes the received sound source data and transmits the processed sound source data to an external audio system as RF signals, comprising the steps of:
accessing the server through the network to transmit jukebox authentication information including an IP address and a unique ID of a jukebox terminal;
transmitting a request for one or more pieces of sound source data in a corresponding playlist to the server if authentication is verified by the server;
receiving the requested sound source data; and
transmitting the received sound source data to the audio system using the RF transmission means.
